(19) United States
(12) Patent Application Publication
(10) Pub. No.: US 2015/0342340 A1
(43) Pub. Date: Dec. 3, 2015

(54) In-Vehicle Riding and Viewing Platorm for Dogs

(71) Applicant: Michael Robert Gonzalez, Laguna Beach, CA (US)

(72) Inventor: Michael Robert Gonzalez, Laguna Beach, CA (US)

(21) Appl. No.: 14/289,659

(22) Filed: May 29, 2014

(51) Int. Cl. A47B 31/06; A47B 13/02; A01K 29/00

(52) U.S. Cl. CPC A47B 31/06; A01K 29/00; A47B 13/02

(57) ABSTRACT

The invention is a system of components that when assembled within a vehicle creates an elevated, stable and comfortable riding platform for dogs (6) (7). The invention achieves this uniquely by substantially filling existing volumes of space in the vehicle with components made of compressible yet structurally firm material such that a large elevated platform emerges that is bound by three existing surfaces in the vehicle and that moves in lock step with the vehicle's motion. The invention assembles and disassembles quickly and has no attachment points to any part of the vehicle interior. Dogs can assume the natural down resting position and experience safety, comfort and a visual experience usually only available to human passengers along with greatly reduced anxiety and fewer incidents of motion sickness.

### CROSS-REFERENCE TO RELATED APPLICATIONS

Related to provisional patent application U.S. 61/956,082

### BACKGROUND

1. Field of Invention

This invention relates to pet accessories, specifically to such accessories that are used to provide containment, comfort or safety of pets while being transported in vehicles.

2. Description of Prior Art

Car seats are made for humans to sit upon. Dogs riding in vehicles are faced with two equally bad choices. (a) They may sit or stand upright-positions that they cannot maintain for very long and in which they are easily tossed around or into the legroom area by the frequent starting, stopping, turning and swerving of the vehicle or (b) they may lie prone on the seat where they easily develop motion sickness brought on by the disconnect between the motion sensed by the body and their fixed view of the inner confines of the vehicle. All of this causes anxiety and stress creating an unhappy and often sick pet.

Others have tried to address various parts of this problem in a number of ways. A review of related products on the market at time of this application shows the following prior art categories:
1. Soft material booster seats that typically have three raised sides and that sit atop the vehicle seat's horizontal surface and are fastened down in some way by attachment to the vehicles seat belt. These provide an elevated pocket for smaller dogs but cannot be made large enough for medium or larger dogs. They also can move unpredictably under the influence of vehicle motion and therefore do not feel stable to the pet.
2. Shelf-like devices that rest on the seat surface, typically made of hard plastic and covered in padding, with mechanical legs that extend down into the foot rest area of the back seat. These also tend to move unpredictably under the influence of vehicle motion. Also, they cannot be made thick enough to provide sufficient elevation while remaining reasonably easy to install and remove.
3. Pads that stretch over the full width of the back seat. These create a narrow resting surface on which larger dogs must lie facing the side of the vehicle. They tend to move in reaction to but out of synchronization with vehicle motion and do not solve the problem of the dog being thrown into the foot rest area.
4. Fillers that address the problem of the dog being thrown into the foot rest area but do nothing to provide elevation, view and comfort.
   Additionally, several patents have been granted that fall in the field of invention of this application.
5. U.S. Pat. No. 7,886,694 to Jakubowski, et al. (2011) for a “Pet Booster Seat” shows a concept and design typical of market product category #1 above. This design is clearly not scalable to serve medium and larger dogs. It also requires connection to the vehicle through the seat belt which does not prevent it from moving independently in reaction to the motion of the vehicle. Also, unless the dog is tightly tethered to the booster seat, it does not prevent ejection into the leg room area.
6. U.S. Pat. No. 6,588,365 to Best Wright (2003) for a “Pet booster seat system and method” is similarly suitable for small pets only as the entire apparatus must fit on top of and be tethered to a single seat surface. It also does not address the problem of independent motion induced upon the apparatus by the motion of the vehicle nor the potential for ejection into the leg room areas.
7. U.S. Pat. No. 5,934,754 to Raffa (1999) for an “Automobile pet head rest” does not indicate any direct prior art however it is instructive as an attempt to ameliorate some of the problems that dogs experience in trying to sit up for longer periods of time. A head rest of this design would provide needed additional support for a pet in the sitting position. However it clearly does not solve any of the problems addressed by the invention.

None of the products discovered through market research and none of the relevant designs or methods discovered through a US patent search appear to provide more than one of the three primary characteristics needed to provide the functionality and benefits of the invention. Those three characteristics being: 1) that it can be provided in a size that accommodates medium and larger size dogs, 2) that it provides stability, comfort and safety under most riding conditions by moving in lock step with vehicle motion and 3) that it enables external viewing by the dog from the down resting position. These characteristics are primarily what enable the invention to provide enjoyable, safe and anxiety-free experiences for dogs riding in vehicles.

### SUMMARY

The invention is a system of components that are made of slightly compressible yet structurally firm material and of predetermined sizes and shapes so that they can be assembled into a stable, horizontal, elevated platform in a most vehicles. The platforms so assembled enable one or more dogs to have an enhanced in-vehicle riding and visual experience from their natural down resting position.

### Objects and Advantages

Objects and advantages of the present invention are:
(a) The invention is comprised of a plurality of components of predetermined size, shape and material composition, two or more of which are assembled together to volumetrically fill portions of a vehicle's passenger space in such a way that an elevated riding platform is created. Common assemblages are (but not limited to) the following: rear seat platform, front passenger seat platform, rear seat platform with extender and various assemblies for cargo areas in hatchbacks, SUVs and Minivans. With the invention, comfortable and safe elevated riding surfaces for dogs can be created in multiple places throughout the vehicle.
(b) The assemblage and components are also assisted by appropriately placed strips of Velcro or similar fastening artifacts. Since the core material of the components is compressible, the adjustability of front seat position can also be used to urge the components together to add additional stability to the assemblage. No direct attachment to any part of the vehicle is required. The platform components are user-assembled and can be installed and un-installed in seconds.
(c) The platforms thus created move in lock step with vehicle motion, front-to-rear, side-to-side and up and down. A dog immediately recognizes the stability of the surface while in motion, unlike other booster devices that can move independently in reaction to vehicle motion.
(d) After stepping up onto the surface of the platforms so created, the dog passenger can assume a natural down resting position and still enjoy the same visual experience as human passengers through any of the vehicle windows while feeling comfortable and secure under most normal driving condition.
(e) The platform's level resting surface is encased on three sides by existing vehicle interior surfaces. In the case of a back seat installation, the back side of the front seat, the inner door panel (or side wall of the interior in the case of a two door vehicle) and the back seat riser surface together form a three-sided enclosure that provides a high degree of safety for a dog without having to use a tethering system.
(f) Each component piece may be finished with batting and a variety of fabrics that contributes to its rigidity, comfort and appearance. Zippers provide means to remove and clean surfaces.

### DRAWING FIGURES

In the drawings, different views of the same component have the same number but different alphabetic suffixes.

FIGS. 1.A and 1.B show top and side view respectively of a component of the invention used in the rear seat area of a vehicle. Typical placement of handle, Velcro attachment strips and zipper are also shown. The top view also represents the bottom view as the component is reversible.

FIGS. 2.A and 2.B are top view and side view of a companion component also utilized in the rear seat area of a vehicle.

FIG. 3 shows a cross section typical of all of the invention components representing their material composition as described herein.

FIG. 4 shows the typical arrangement of the two components from FIG. 1 and FIG. 2. Placed and attached in the manner indicated the two components create a basic riding platform in the rear seat area of most vehicles.

FIGS. 5.A and 5.B show top and side view respectively of the primary component of the invention used in the front passenger seat area of a vehicle. Typical placement of handle, Velcro attachment strips and zipper are also shown. The top view also represents the bottom view as the component is reversible.

FIGS. 6.A and 6.B are top view and side view of a companion component also utilized in the front passenger seat area of a vehicle.

FIG. 7 shows the typical arrangement of the two components from FIG. 4 and FIG. 5. Placed and attached in the manner indicated the two components create a basic riding platform in the front passenger seat area of most vehicles.

FIG. 8 shows an auxiliary component used to gain extra platform elevation for smaller dogs if desired.

FIG. 9 shows an auxiliary component used to level the platform surface in vehicles with seats that slope down severely from front to back.

FIG. 10 shows a top view of a rear seat installation with an auxiliary cushion added to extend the platform to accommodate two or more dogs.

FIG. 11 shows the two components of FIG. 1 and FIG. 2 reconfigured as a dog travel bed.

FIG. 12 shows FIG. 1 component placed on the ground immediately below a vehicle running board to provide easier ingress and egress for small, aging or infirm dogs.

FIG. 13 shows the invention in its most basic assembly and most common placement in a typical vehicle.

FIG. 14 shows the invention in other combinations and placements in a typical vehicle.

### REFERENCE NUMERALS IN DRAWINGS

1 convenient carry handle that also aids installation and removal from vehicle.
2 Velcro or other fabric fastening means.
3 zippers for fabric cover removal and cleaning.
4 fabric cover.
5 compressible but structurally firm composition material.
6 top view of typical vehicle rear seat
7 running board, an example of entry and exit step surface in vehicles
8 invention shown as assembly of two or more components-basic installation in rear seat
9 other in-vehicle installation examples

### DESCRIPTION

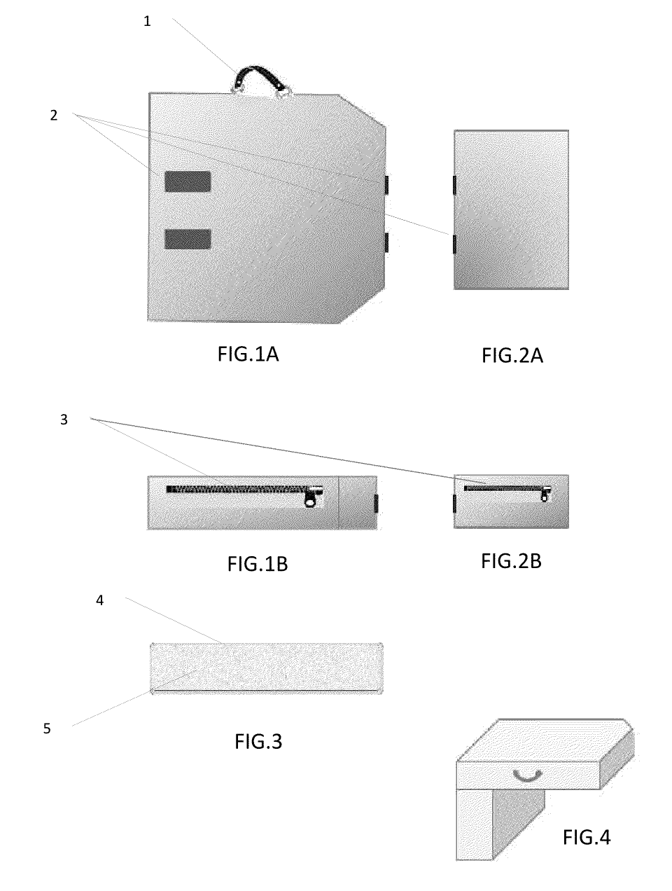

### FIGS. 1A, 1B, 2A, 2B, 3, 4, 12—Preferred Embodiment

A preferred embodiment of the present invention is illustrated in FIG. 4 which is an assemblage of two components, one illustrated in FIG. 1A (top or bottom view) and FIG. 1B (side view) and the other illustrated in FIG. 2A (top or bottom view) and FIG. 2B (side view). These components are sized and shaped so that in combination they substantially fill the volume of the legroom area plus a space above the horizontal seat surface. The result is a platform that is at a higher elevation by a desired amount above the existing level of the seat, said platform bounded by the back surface of the front seat, the side door inner panel and the riser portion of the back seat. This can be seen clearly in FIG. 12 (6). The resulting platform has a substantially larger horizontal surface than the portion of the rear vehicle seat on which it rests and also eliminates the associated legroom cavity.

The material composition of the core of the components FIG. 3 (5) is high density, very firm foam or any other material that can provide an appropriate combination of structural strength, surface softness and compressibility, these being characteristics upon which the invention relies to create a comfortable riding platform that will move in lock-step with vehicle motions.

The core is wrapped in any fabric cover (4) that provides sufficient friction on the inner side such that it does not move easily relative to the core when under influence of vehicle motions.

On the fabric there are sewn, or otherwise attached, any number of strips of Velcro FIGS. 1A (2) and 2A (2) or material of similar functionality. The purpose of these strips are to fasten the components together as required to create the volume filling shape or alternatively to provide extra friction where needed between the assembly and the vehicle's interior surfaces to increase stability.

The fabric coverings are fitted with common zippers FIGS. 1B (3) and 2B (3) so that the cover may be removed and cleaned. A handle is attached to the larger components FIG. 1A (1) for easier transport and assembly and quicker conversion to other uses and configurations that are part of the invention.

Once the invention assembly is in place, the front passenger seat adjustment can be used to apply compression to it. This increases stability and firmness of fit between the assembled invention and the vehicle.

### FIGS. 5A, 5B, 6A, 6B, 7, 8, 9, 10, 13

### Additional Embodiments

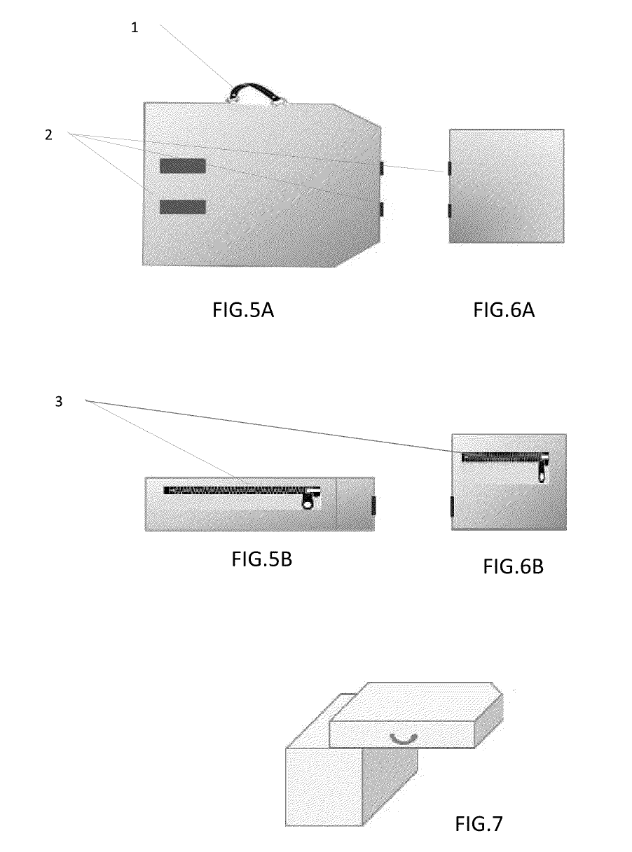

An additional embodiment is shown in FIG. 7 which is an assemblage of the components shown in FIGS. 5A, 5B, 6A and 6B designed to create the invented stable and elevated platform in the front passenger seat. In these figures, the top or horizontal cushion in FIG. 5 is narrower and has a different miter angle to accommodate the size and shape of a typical front bucket seat of a vehicle. The cushion for the foot rest gap FIG. 6 is broader to fill the larger foot rest area found in the front passenger seat of vehicles.

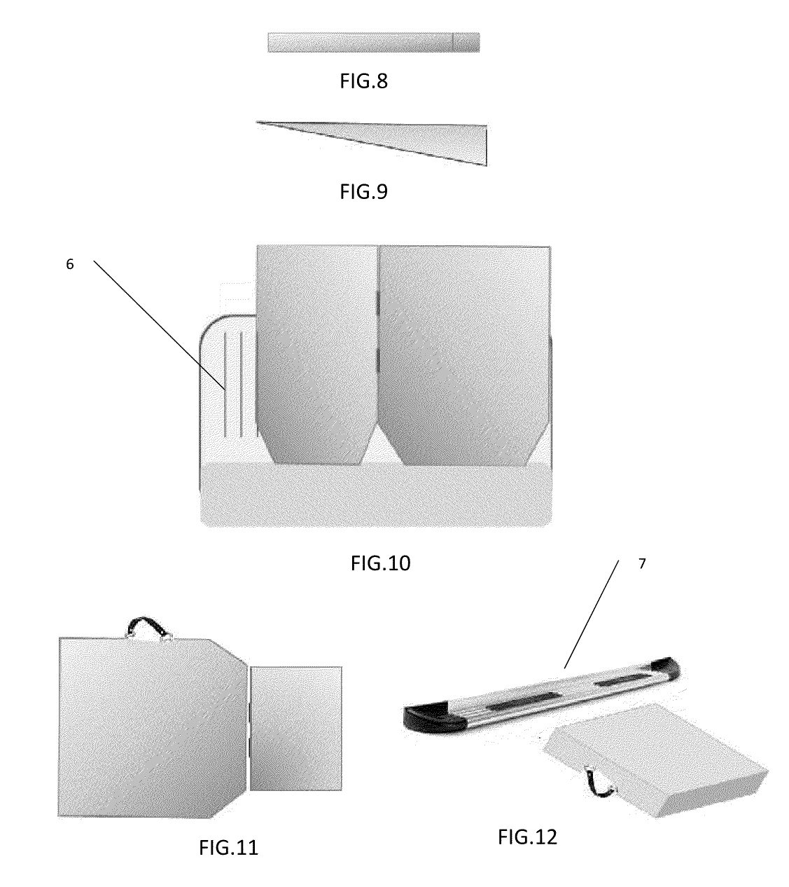

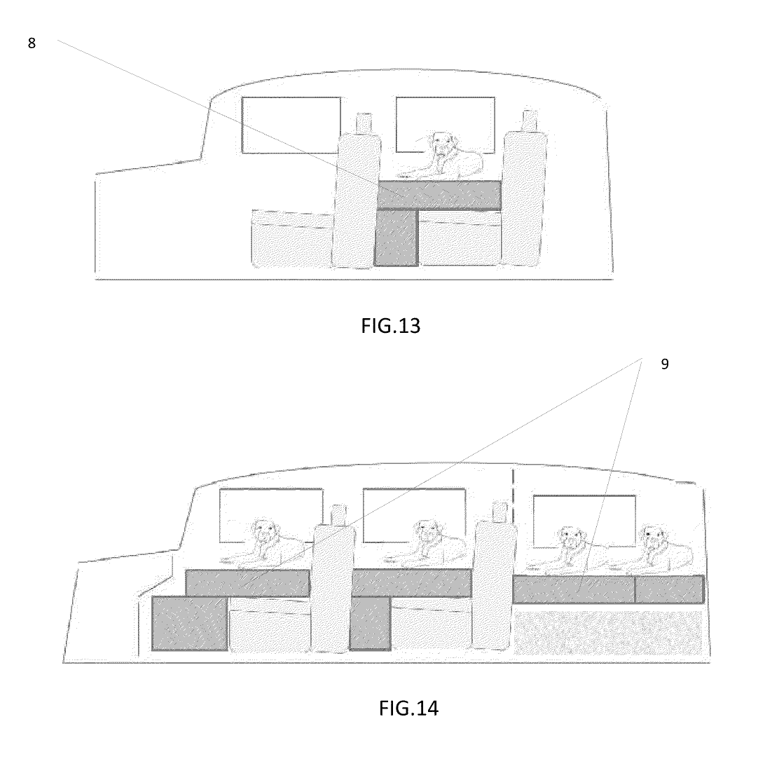

Additional embodiments of the invention can be created with specialty pieces such FIG. 8 which provides incrementally higher elevation of the riding platform for smaller dogs, FIG. 9 which compensates for seats that are more dramatically sloped downward toward the back riser of the seat, FIG. 10 that shows the extra horizontal component attached side to side with Velcro (2) to the preferred embodiment in such a way that the resulting assembly accommodates two dogs in the rear seat while leaving room for a human passenger if desired and lastly FIG. 13 (7) that shows a number of components of different sizes that can be combined to fill cargo areas of vehicles.

### FIGS. 11, 12

### Alternative Embodiments

Certain of the components of the invention can be removed from the vehicle and their preferred embodiments and re-purposed for alternate uses such as (FIG. 11) pet beds and (FIG. 12) as step in and step out assistance platforms for older or infirm dogs.

### CONCLUSION, RAMIFICATIONS, AND SCOPE

Accordingly, the reader will see that the invention:
1. Can be easily installed in any vehicle, without requiring any physical attachment to the interior, where it creates stable, comfortable, elevated riding surfaces for dogs.
2. Accomplishes this by using various combinations of the invention's purposefully sized and shaped components made of compressible yet structurally rigid core material and volumetrically filling certain spaces of the vehicles interior.
3. Creates a larger horizontal surface than is otherwise found in the typical vehicle and as such can accommodate all size dogs and not only smaller dogs as currently served by prior art products and patents.
4. Creates platforms that move in lock step with vehicle motion and are bounded on at least three sides by existing vertical surfaces of the vehicle interior.
5. Enables a riding dog to assume the down resting position while retaining the ability to see out of any window in the vehicle, sharing the visual experience of the ride with the driver and other human passengers.
6. Delivers a more comfortable and safer ride for medium and larger dogs than any prior art or invention, creating a sense of confidence and appreciation in the dog.
7. Counteracts most if not all of conditions experienced within a vehicle in-motion that cause anxiety and motion sickness in dogs.
8. Eliminates danger of being thrown into the legroom area or being tossed unpredictably and unsafely throughout the vehicle interior whereas prior art implementations only achieve this by tethering the dog to the vehicle's seat belts.

Although the descriptions above contain many specificities, these should not be construed as limiting the scope of the invention but as merely providing illustrations of some of the presently preferred embodiments of this invention. For example, many different safe, comfortable spaces for different purposes may be constructed within a vehicle using the system and methods of the invention.

Thus the scope of the invention should be determined by the appended claims and their legal equivalents, rather than by the examples given.

I claim:

1. A system, method and plurality of components for creating in-vehicle riding and viewing platforms for dogs, where
(a) said components are of predetermined shapes and sizes and composed substantially of lightweight, compressible but structurally firm material, and where
(b) the components are attached together in various combinations and placed in vehicles such that said combinations substantially and volumetrically fill voids in the passenger areas and wherein they may be further urged into a tight fit by adjustment of vehicle seat positions, such that
(c) the combinations of the components create elevated horizontal riding platforms that when subjected to vehicle motions, will not move independently of said vehicle motion, and
whereas the improvements are that the platforms are significantly larger than otherwise attainable, are elevated above the typical horizontal surfaces found in a vehicle, are bounded on three sides by existing vertical surfaces of the vehicle and provide a high degree of stability, safety, comfort and external viewing for dogs riding in vehicles in the down resting position.

2. The system, method and plurality of components for creating in-vehicle riding and viewing platforms for dogs of claim 1 where the core material (a) is polyurethane foam within a predetermined range of density, weight and compression resistance.

3. The system, method and plurality of components for creating in-vehicle riding and viewing platforms for dogs of claim 1 where the core material (a) is covered in a fabric encasement with zipper for removal and cleaning.

4. The system, method and plurality of components for creating in-vehicle riding and viewing platforms for dogs of claim 1 where the component's fabric encasement (3) has attached strips of Velcro or equivalent in a plurality of predetermined places such that it becomes more firmly fixed in place with respect to the vehicle internal surfaces.
